(19) United States
(12) Patent Application Publication
(10) Pub. No.: US 2022/0266790 A1
(43) Pub. Date: Aug. 25, 2022

(54) RESOLVER-POSITIONING RESIN PIN PORTION STRUCTURE

(71) Applicants: TAMAGAWA SEIKI CO., LTD., Nagano (JP); HONDA MOTOR CO., LTD., Tokyo (JP); IWATAKI GIKEN CO., LTD., Tokyo (JP)

(72) Inventors: Shinichi HARA, Nagano (JP); Kazuya KANETA, Saitama (JP); Eiji IWATAKI, Tokyo (JP)

(73) Assignees: TAMAGAWA SEIKI CO., LTD., Nagano (JP); HONDA MOTOR CO., LTD., Tokyo (JP); IWATAKI GIKEN CO., LTD., Tokyo (JP)

(21) Appl. No.: 17/584,851

(22) Filed: Jan. 26, 2022

(30) Foreign Application Priority Data
Feb. 25, 2021 (JP) 2021-028305

(51) Int. Cl. B60R 22/24

(52) U.S. Cl. CPC B60R 22/24; B60R 2022/1818

(57) ABSTRACT

The present invention realizes an improvement in the moldability of a resin portion that is injection-molded to an annular stator. A plurality of collar portions formed integrally with a peripheral edge of the insulating cover so as to project beyond the outer diameter of the annular stator, and a resin pin molded integrally with one of the collar portions, wherein a collar resin portion of the collar portion and a resin pin resin portion of the resin pin are integrated with each other when seen from above, and a first outer diameter of the collar resin portion is larger than a second outer diameter of the resin pin resin portion.

### BACKGROUND OF THE INVENTION

### 1. Field of the Invention

The present invention relates to a resolver-positioning resin pin portion structure, and more particularly to a novel improvement for achieving improved moldability by reducing the amount of resin in a resin portion of a resin pin and thereby reducing the injection pressure required during injection molding.

### 2. Description of the Related Art

A “shoulder anchor for a seatbelt device” of Japanese Patent Application Publication No. 2000-177534 can be cited as an example of a configuration for removing the resin that is conventionally used in this type of component.

More specifically, as shown in FIGS. 5 and 6, in a shoulder anchor 7, a reduced-thickness portion 10b formed by reducing the thickness of resin 12 is provided in a part of a guide portion 10 on the opposite side to a webbing sliding portion 10a, the guide portion 10 having a hole 9 through which webbing, or in other words a seatbelt, not shown in the figures, is passed. The length of the reduced-thickness portion 10b in a webbing width direction W is substantially equal to the length of the guide portion 10 in the webbing width direction W, and the reduced-thickness portion 10b is shaped so as to penetrate in an orthogonal direction to the webbing width direction W and such that one edge of an insert metal fitting 11 is exposed therefrom. By providing the reduced-thickness portion 10b, contraction of the resin 12 during molding is effectively absorbed, leading to an improvement in moldability during resin molding.

Further, FIGS. 3 and 4 show a conventional configuration of a resolver manufactured in-house by the present applicant.

In FIG. 3, a component denoted by the reference numeral 1 is a laminated annular stator, for example, and projecting magnetic poles 2 projecting integrally inward at predetermined angular intervals are provided on an inner surface 1a of the annular stator 1.

An annular insulating cover 3 formed integrally by injection molding is formed on respective end surfaces 1A, 1B (in other words, a front surface and a rear surface) of the annular stator 1.

A stator winding 4 is wound around each projecting magnetic pole 2 via the insulating cover 3, and a plurality of collar portions 5, 5A, 5B are formed from collar resin portions 16 integrally with a peripheral edge 3a of the insulating cover 3 so as to project further outward than the outer diameter of the annular stator 1.

In one collar portion 5 among the collar portions 5, 5A, 5B, a resin pin 15 that is formed integrally with the collar portion 5 and used for positioning when a resolver is attached to a partner side, not shown in the figures, is provided on a resin pin resin portion 17 molded integrally with the collar resin portion 16.

Note that a hole 15A is formed in the resin pin 15 so as to extend in the axial direction thereof.

The collar resin portion 16 of the collar portion 5 and the resin pin resin portion 17 of the resin pin 15, when seen from above, are both circular but partially joined. A first outer diameter D1 of the collar resin portion 16 is set to be identical to a second outer diameter D2 of the resin pin resin portion 17 (D1=D2).

Further, a length from the second outer diameter D2 of the resin pin 15 to the projecting magnetic pole 2 is set at a first length L1.

In an upper portion position of the insulating cover 3, as seen on the figure, a terminal pin holding portion 3A is formed integrally with the insulating cover 3 so as to be oriented outward, similarly to the collar resin portions 16, and a plurality of terminal pins 3B are provided on the terminal pin holding portion 3A for use during signal input and output.

[Patent Document] JP2000-177534

### SUMMARY OF THE INVENTION

With the conventional seatbelt-fastening shoulder anchor and resolver-positioning resin pin portion structure having the configurations described above, the following problems exist.

In the case of the seatbelt-fastening shoulder anchor shown in FIGS. 5 and 6, by forming the reduced-thickness portion 10b in the lower portion of the resin 12, although the amount of resin required during injection molding is reduced, leading to an improvement in moldability, the hole 9 through which the seatbelt is passed is formed near the reduced-thickness portion 10b, and therefore, when the reduced-thickness portion 10b is increased in size such that the amount of resin is reduced excessively, the strength of the hole 9 decreases. Hence, there is a limit to the amount by which the resin can be reduced, and accordingly a limit to the amount by which the injection pressure can be reduced.

Further, in the case of the conventional configuration shown in FIGS. 3 and 4, since the first outer diameter D1 of one of the plurality of collar resin portions 16 is identical to the outer diameter D2 of the resin pin resin portion 17 formed integrally therewith, the amount of resin used during simultaneous molding of the respective resin portions 16, 17 is too large. Moreover, since the other collar resin portions 16, 16, the terminal pin holding portion 3A, and the insulating cover 3 are also molded at the same time during the integral molding, it is difficult to achieve an improvement in moldability by reducing the injection pressure during the integral molding.

The present invention has been designed to solve the problems described above, and an object thereof is to achieve an improvement in moldability by reducing the amount of resin used in the resin pin resin portion 17 and thereby reducing the injection pressure during injection molding.

A resolver-positioning resin pin portion structure according to the present invention is constituted by an annular stator having projecting magnetic poles that project inwardly at predetermined angular intervals, an insulating cover formed on respective end surfaces of the annular stator, a stator winding provided on each projecting magnetic pole via the insulating cover, a plurality of collar portions formed integrally with a peripheral edge of the insulating cover so as to project beyond the outer diameter of the annular stator, and a resin pin molded integrally with one of the collar portions, wherein a collar resin portion of the collar portion and a resin pin resin portion of the resin pin are integrated with each other when seen from above, and a first outer diameter of the collar resin portion is larger than a second outer diameter of the resin pin resin portion. Further, the collar resin portion and the resin pin resin portion are formed by integral molding and have a gourd shape when seen from above.

With the resolver-positioning resin pin portion structure according to the present invention, having the configuration described above, the following effects can be acquired. In the resolver-positioning resin pin portion structure constituted by the annular stator having the projecting magnetic poles that project inwardly at predetermined angular intervals, the insulating cover formed on the respective end surfaces of the annular stator, the stator winding provided on each projecting magnetic pole via the insulating cover, the plurality of collar portions formed integrally with the peripheral edge of the insulating cover so as to project beyond the outer diameter of the annular stator, and the resin pin molded integrally with one of the collar portions, the collar resin portion of the collar portion and the resin pin resin portion of the resin pin are integrated with each other when seen from above, and the first outer diameter of the collar resin portion is larger than the second outer diameter of the resin pin resin portion. Hence, the thickness of the resin pin resin portion can be greatly reduced, whereby an improvement in moldability can be achieved as a result of a reduction in injection pressure during integral molding.

Further, the collar resin portion and the resin pin resin portion are formed by integral molding and have a gourd shape when seen from above, and therefore the amount of resin used for the resin pin resin portion is clearly reduced in comparison with the conventional configuration.

### BRIEF DESCRIPTION OF THE DRAWINGS

FIG. 1 is a plan view showing a resolver-positioning resin pin portion structure according to the present invention;

FIG. 2 is an enlarged sectional view of a resin pin, taken along an A-A line in FIG. 1;

FIG. 3 is a plan view showing a conventional configuration;

FIG. 4 is an enlarged sectional view of a resin pin, taken along an A-A line in FIG. 3;

FIG. 5 is a schematic view showing a conventional configuration; and

FIG. 6 is a sectional view taken along a 1B-1B line in FIG. 5.

### DESCRIPTION OF THE PREFERRED EMBODIMENTS

In the resolver-positioning resin pin portion structure according to the present invention, an improvement in moldability is achieved by reducing the amount of resin used in the resin pin resin portion 17 and thereby reducing the injection pressure during injection molding below that of the conventional configuration.

### Embodiment

A preferred embodiment of the resolver-positioning resin pin portion structure will be described below together with the figures.

Note that identical or similar parts to the conventional examples will be described using identical reference symbols.

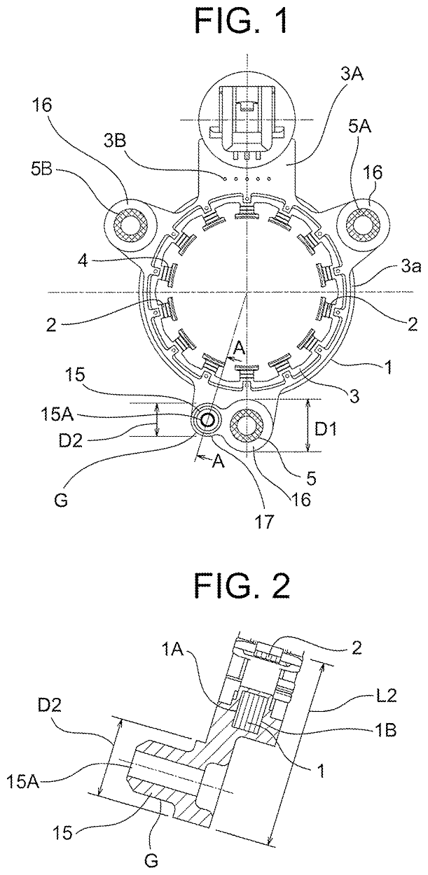

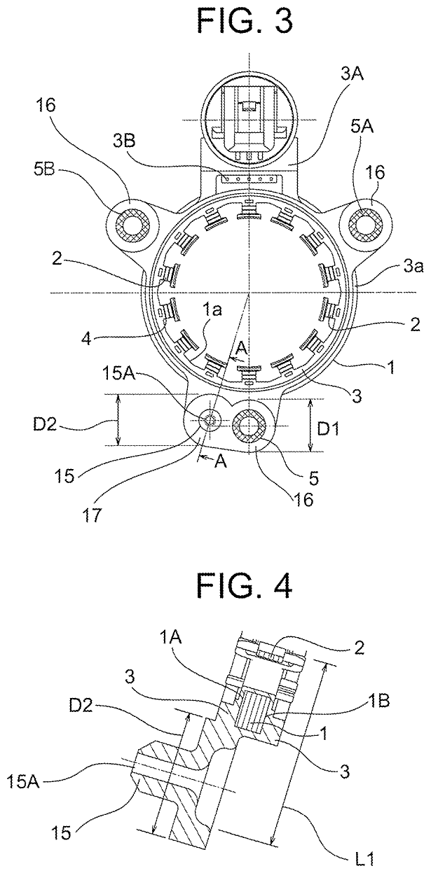

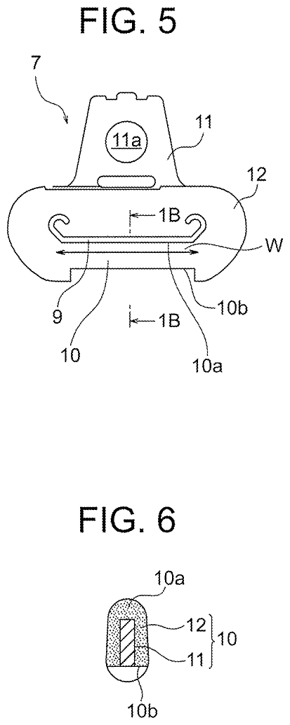

In FIG. 1, the component denoted by the reference numeral 1 is the laminated annular stator, for example, and the projecting magnetic poles 2 projecting integrally inward at predetermined angular intervals are provided on the inner surface 1a of the annular stator 1.

The annular insulating cover 3 formed integrally by injection molding is formed on the respective end surfaces 1A, 1B (in other words, the front surface and the rear surface) of the annular stator 1.

The stator winding 4 is wound around each projecting magnetic pole 2 via the insulating cover 3, and the plurality of collar portions 5, 5A, 5B are formed integrally with the peripheral edge 3a of the insulating cover 3 so as to project further outward than the outer diameter of the annular stator 1.

One collar portion 5 among the collar portions 5, 5A, 5B is provided with the resin pin 15 that is injection-molded integrally with the collar portion 5 and used for positioning when a resolver is attached to a partner side of a vehicle, a machine tool, or the like, not shown in the figures.

Note that the hole 15A is formed in the resin pin 15 so as to extend in the axial direction thereof.

The collar resin portion 16 of the collar portion 5 and the resin pin resin portion 17 of the resin pin 15, when seen from above, are integrated with each other and joined into an integrated form by integral molding such that the circular shapes thereof are broken. Further, the collar resin portion 16 and the resin pin resin portion 17 are molded using an injection molding die, not shown in the figures, so that the first outer diameter D1 of the collar resin portion 16 is larger than the second outer diameter D2 of the resin pin resin portion 17 (D1>D2). Hence, when seen from above, the collar resin portion 16 and the resin pin resin portion 17 have a planar shape on which D1>D2, and therefore the two portions create a gourd shape, thereby forming a resin pin reduced-thickness shape G.

Furthermore, a second length L2 from the second outer diameter D2 of the resin pin 15 to the projecting magnetic pole 2 is set to be shorter than the first length L1 shown on the conventional example in FIG. 4, and likewise here, reduced thickness is achieved.

In an upper portion position of the insulating cover 3, as seen in FIG. 1, the terminal pin holding portion 3A is formed integrally with the insulating cover 3 so as to be oriented outward, similarly to the collar resin portions 16, and the plurality of terminal pins 3B are provided on the terminal pin holding portion 3A for use during signal input and output.

Note that by making the second outer diameter D2 of the resin pin resin portion 17, among the collar resin portion 16 and the resin pin resin portion 17, much smaller (a smaller diameter) than the first outer diameter D1 of the collar resin portion 16, the amount of resin (the thickness) required to form the resin pin resin portion 17 can be greatly reduced, leading to a reduction in the injection pressure required during injection molding, and as a result, an improvement in moldability (molding corresponding to the shape of the die) can be achieved.

In the resolver-positioning resin pin portion structure according to the present invention, by making the second outer diameter (D2) of the resin pin resin portion 17, which is formed integrally with the first outer diameter (D1) of the collar resin portion 16, smaller than the first outer diameter (D1), the resin material of the resin pin resin portion 17 can be greatly reduced, whereby the moldability can be greatly improved due to a reduction in injection pressure, and as a result, the production yield of the resolver can be greatly improved.

What is claimed is:

1. A resolver-positioning resin pin portion structure constituted by an annular stator having projecting magnetic poles that project inwardly at predetermined angular intervals, an insulating cover formed on respective end surfaces of the annular stator, a stator winding provided on each projecting magnetic pole via the insulating cover, a plurality of collar portions formed integrally with a peripheral edge of the insulating cover so as to project beyond the outer diameter of the annular stator, and a resin pin molded integrally with one of the collar portions,
wherein a collar resin portion of the collar portion and a resin pin resin portion of the resin pin are integrated with each other when seen from above, and a first outer diameter of the collar resin portion is larger than a second outer diameter of the resin pin resin portion.

2. The resolver-positioning resin pin portion structure according to claim 1, wherein the collar resin portion and the resin pin resin portion are formed by integral molding and have a gourd shape when seen from above.
